(19) United States
(12) Patent Application Publication
(10) Pub. No.: US 2005/0246900 A1
(43) Pub. Date: Nov. 10, 2005

(54) Multi-use gardening tool with locking extension handles

(76) Inventor: Gerard James Simpson, Trabuco Canyon, CA (US)

Correspondence Address: BARBER LEGAL, P.O. BOX 16220, GOLDEN, CO, 80402-6004, US

(21) Appl. No.: 11/126,898

(22) Filed: May 10, 2005

Related U.S. Application Data
(60) Provisional application No. 60/569,495, filed on May 10, 2004.

(51) Int. Cl. B26B 3/06

(52) U.S. Cl. 30/153; 30/341

(57) ABSTRACT

Gardening shears may have a folding handle and handle extension connected by a pivot, with a projecting pin on one of the handle or extension which is received into two pin receiving channels on the other of the handle extension or handle. The handle extension nests into the handle when not in open position. The pin is located at a distance from the pivot. When the pivot is rotated, the pin enters the first channel, which is parallel to the direction of rotation of the pivot. The pivot may then slide in an elongated pivot channel, causing the pin to depart the first receiving channel and lock into the second receiving channel. The distance between the pivot and the pin and channels provides a greater lever arm to absorb torque, and the combination of two pin receiving channels allows the device to more securely lock into place.

### CROSS-REFERENCE TO RELATED APPLICATIONS

This application claims the priority and benefit of U.S. Provisional Application No. 60/569,495 filed May 10, 2004 in the name of the same inventor, Gerard James Simpson, and entitled MULTI-USE GARDENING TOOL WITH LOCKING EXTENSION HANDLES, the entire disclosure of which is incorporated herein by this reference thereto.

### STATEMENT REGARDING FEDERALLY FUNDED RESEARCH

This invention was not made under contract with any agency of the US Government, nor by any agency of the US Government.

### FIELD OF THE INVENTION

This invention relates generally to cutlery and specifically to gardening shears having extending/foldable handles with the locking mechanisms.

### BACKGROUND OF THE INVENTION

Gardening shears suffer from the need for long handles. This is occasioned by the need to apply considerable torque to the device in the form of force to the handles. Unlike most unrelated cutting applications (such as wire strippers, nail clippers, pliers, etc.) a pair of gardening shears may reasonably be expected to be used to cut wooden branches and saplings. While a pair of pliers, tin snips, household scissors, nail clippers, wire strippers or the like, all of which may advantageously have relatively short handles, gardening shears customarily have handles roughly between a foot and three feet long.

This adds considerably to the bulk and inconvenience of the garden shears. It is not normally either easy or safe to tuck a pair of gardening shears into a small tool box on a riding mower or in a back pocket.

One solution to this problem is to add folding handles to gardening shears. However, such folding handles must have extremely sturdy locking mechanisms to prevent the handles from folding up under imposed loads, a potential safety hazard.

A search in United States Patent Classification 30, cutlery, particularly in subclass 255 (dealing with all types of shears having folding handles) reveals a large number of items which deal with light use applications like cutting finger nails, wires or paper.

The following U.S. patent Nos.:
U.S. Pat. No. 6,065,213, issued May 23, 2000 to Rivera,
U.S. Pat. No. 3,781,992 issued Jan 1, 1974 to Barr,
U.S. Pat. No. 3,766,648 issued Oct. 23, 1973 to Chundelak, Jr,
U.S. Pat. No. 2,588,939 issued Mar. 11, 192 to E. P. Selander,
U.S. Pat. No. 2,192,725 issued Mar. 5, 1940 to E. Williams,
U.S. Pat. No. 2,568,605 issued Sep. 18, 1951 to R. D. Bennett,
U.S. Pat. No. 2,126,699 issued Aug. 16, 1938 to B. J. Florian,
U.S. Pat. No. 1,524,694 issued Feb. 3, 1925 to L. Di Maio,
U.S. Pat. No. 1,420,523 issued Jun. 20, 1922 to A Coryell,
U.S. Pat. No. 1,09,0130 issued Mar. 17, 194 to D. Borgetti,
U.S. Pat. No. 858,003 issued Jun. 25, 1907 to F. W. Klever,
U.S. Pat. No. 762,725 issued Jun. 14, 1904 to E. Kaufinann,
U.S. Pat. No. 631,403 issued Aug. 22, 1899 to A. S. E. Metcalf,
U.S. Pat. No. 542,601 issued Jul. 9, 1895 to F. R. Baker,
U.S. Pat. No. 425,560 issued Apr. 15, 1890 to J. Badger, and
U.S. Pat. No. 200,754 issued Feb. 26, 1878 to L. A. Pichon, all show some type of light duty scissors having some ability to fold into a smaller shape. None show any sliding pivot and two channel pin receiver mechanism. All have a single fold design with relatively short handles, due to the fact that they are for light duty and there is no need for longer handles to allow users to apply increased torque.

Of slightly more interest are various types of “multipurpose” tools such as are used for wire cutters, small pliers and the like. U.S. patent Nos.:
U.S. Pat. No. 5,978,993 issued Nov. 9, 1999 to Rivera,
U.S. Pat. No. 5,809,599 issued Sep. 22, 1998 to Frazer,
U.S. Pat. No. 5,062,173 issued Nov. 5, 1991 to Collins et al,
U.S. Pat. No. 4,744,272 issued May 17, 1988 to Leatherman,
U.S. Pat. No. 4,648,145 issued Mar. 10, 1987 to Miceli, and
U.S. Pat. No. 4,330,937 issued May 25, 1982 to Cope all show various types folding utility knives or pliers. Most have a single fold design in which the handles fold only near the main pivot of the pliers, wrench or scissors, and thus relatively short handles, due to the fact that they are for light duty and there is no need for longer handles to allow users to apply increased torque.

One other item of interest is U.S. Publication No. 2004/0010924 in the name of Hung et al, published Jun. 22, 2004, which at least shows double fold handles for use on a pair of gardening shears. However, that design lacks a sliding pivot, pin and two channel pin receiver mechanism.

One item mentioned previously, U.S. Pat. No. 4,744,272 issued May 17, 1988 to Leatherman, does have double fold handles with an ear and notch locking mechanism. However, that item is a “multipurpose” tool, which in turn causes substantial structural deficiencies viewed against the present invention. The '272 item structure is a set of double fold handles which have terminal portions folding out from a position nested within the portions closer to the pivot. In use, the terminal portions are the location for a user's hand, as the longer lever arm is intended to provide extra leverage. The narrower terminal portions of the handles of the '272 item mean that users must press the palm of the hand against a narrower handle when attempting to generate greater torque on the object held within the jaws of the tool. This tool is further lacking in pruning shears (it has gripping jaws 10a, 10b, which might have a very short un-numbered and un-suggested cutting portion but which are clearly identified as being for gripping). It will be appreciated that pruning shears would require a large amount of force to operate, force generated as torque by the user's hand on the terminal handle portions. The ear and notch locking mechanism it teaches also lacks a pair of perpendicular channels for receiving the pin. The short distance from the ear to the pin about which it rotates means that considerable torque is borne by the very short lever arm defined by the two items. In detail, the short lever arm taught in the '272 item FIG. 5 is defined by reference numerals 44 and 22, which are almost adjacent at the “end” of one handle. Other embodiments such as that in FIG. 25, 26, 27 are defined by ear 479 and the nearby point of rotation 422, a distance almost as short. In general, since this is a pair of gripping jaws and the locking mechanism has an extremely short baseline forming the lever arm of the lock itself (which must bear the torque of use), the structures taught in that item of prior art are not suitable for gardening: different structures are needed for gardening.

It would be advantageous to provide a pair of gardening shears having long curved cutting blades suitable for cutting through garden flora.

It would further be advantageous to provide a pair of gardening shears having long folding handles able to lock securely in place.

It would yet further be advantageous to provide a pair of gardening shears having folding handles with an extremely secure locking mechanism having a long distance forming the lever arm of the locking mechanism and having long secure channels to retain the device handles in the proper configuration during heavy use.

### SUMMARY OF THE INVENTION

General Summary

The present invention teaches that a pair of gardening shears may have a folding handle and handle extension connected by a pivot, with a projecting pin on one of the handle or extension which is received into two receiving channels on the other of the handle extension or handle. When the pivot is rotated, the pin enters the first channel, which is parallel to the direction of rotation of the pivot. The pivot may then be slid in an elongated pivot channel, causing the pin to depart the first channel and lock into the second channel.

The large length of the distance between the pivot and the pin and channels provides a greater lever arm to absorb torque when force is applied to the handle extensions in use, an important property necessary for cutting plants (which may be wood branches of considerable hardness). In addition, the combination of two pin receiving channels allows the device to more securely lock into place.

In embodiments, one or two of the handles may have the locking mechanism, in preferred embodiments, both handles use the locking mechanism.

Summary in Reference to Claims

It is therefore a first aspect, advantage, objective and embodiment of the invention to provide: an improved pair of gardening shears, having a handle and handle extension rotatably connected by a pivot passing through both handle and handle extension, wherein the improvement comprises:
first and second shear blades;
an elongated pivot channel through which the pivot passes;
at least one protruding pin located at a first distance from the pivot;
a first pin receiving channel parallel to the direction of rotation of the pivot and located at the first distance from the pivot, and
a second pin receiving channel perpendicular to the first pin receiving channel and parallel to the elongated pivot channel and communicating with an end of the first pin receiving channel.

It is therefore another aspect, advantage, objective and embodiment of the invention to provide an improved pair of gardening shears wherein the second pin receiving channel has a length of at least 0.50 inches.

It is therefore another aspect, advantage, objective and embodiment of the invention to provide an improved pair of gardening shears wherein the first pin receiving channel has a length of at least 0.25 inches.

It is therefore another aspect, advantage, objective and embodiment of the invention to provide an improved pair of gardening shears wherein the first and second shear blades have a length of at least 1.25 inches.

It is therefore another aspect, advantage, objective and embodiment of the invention to provide an improved pair of gardening shears wherein the first distance is at least 0.625 inches.

It is therefore another aspect, advantage, objective and embodiment of the invention to provide an improved pair of gardening shears wherein the first and second shear blades are curved.

It is therefore another aspect, advantage, objective and embodiment of the invention to provide an improved pair of gardening shears further comprising:
at least one tool selected from the group consisting of: a peeler blade for grafting plants, a serrated knife for green plant cuttings, soil knife for stirring soil, a weeder for removal of weeds from earth, concrete crevice cleaners, a saw blade, as well as more general purpose tools such as screwdrivers, can openers, files, rulers, a flat blade knife for general purpose use, a clip blade knife and combinations thereof, the selected tool being rotatably attached to the pivot.

It is therefore another aspect, advantage, objective and embodiment of the invention to provide an improved pair of gardening shears wherein the first and second pin receiving channels form a single L-shaped pin retainer.

It is therefore another aspect, advantage, objective and embodiment of the invention to provide an improved pair of gardening shears wherein such handle extension folds to a first position nested within the handle and to a open second position.

It is therefore another aspect, advantage, objective and embodiment of the invention to provide a pair of gardening shears comprising:
first and second handles rotatably connected at a main pivot, the first and second handles having respective first and second shear blades facing each other to form a set of shears, at least the first handle having a longitudinal handle channel having a width greater than the width of the main pivot and greater than the width of the shear blades;
the first and second shear blades being curved;
at least the first handle having a handle extension, a shear pivot and an extension pivot;
the first handle extension rotatably connected to the first handle by the extension pivot, the handle extension having a longitudinal extension channel having a width greater than the width of the first handle, the handle extension having an elongated pivot channel through which the extension pivot passes;
the first handle rotatably connected to the main pivot by the shear pivot;
the first handle having a first position in which the main pivot and shear blades nest within the longitudinal handle channel and a second position in which the main pivot and shear blades extend from the first handle;
the handle extension having a first rotational position in which the first handle nests therein and a second rotational position in which the first handle extends from the handle extension and a third sliding position in which the extension pivot is located at a first part of the pivot channel and a fourth sliding position in which the extension pivot is located at a second part of the pivot channel;
the handle having protruding therefrom at least one pin;
the handle extension having therein a first pin receiving channel parallel to the direction of rotation of the extension pivot and located at a distance from the extension pivot such that when the handle extension is in the third sliding position and is rotated from the first rotatable position to the second rotatable position, the pin passes into the first pin receiving channel; and
the handle extension having therein a second pin receiving channel perpendicular to the first pin receiving channel and parallel to the elongated pivot channel and communicating with an end of the first pin receiving channel, such that when the handle extension is slid from the third sliding position to the fourth sliding position, the pin passes from the first pin receiving channel into the second pin receiving channel.

It is therefore yet another aspect, advantage, objective and embodiment of the invention to provide a pair of gardening shears further comprising:
a second handle having a second handle extension, a second shear pivot and a second extension pivot;
the second handle extension rotatably connected to the second handle by the second extension pivot, the second handle extension having a second longitudinal extension channel having a width greater than the width of the second handle, the second handle extension having a second elongated pivot channel through which the second extension pivot passes;
the second handle rotatably connected to the main pivot by the second shear pivot;
the second handle having a first position in which the main pivot and shear blades nest within the second longitudinal handle channel and a second position in which the main pivot and shear blades extend from the second handle;
the second handle extension having a first rotational position in which the second handle nests therein and a second rotational position in which the second handle extends from the second handle extension and a third sliding position in which the second extension pivot is located at a first part of the second pivot channel and a fourth sliding position in which the second extension pivot is located at a second part of the second pivot channel;
the second handle having protruding therefrom at least a second pin;
the second handle extension having therein a third pin receiving channel parallel to the direction of rotation of the second extension pivot and located at a distance from the second extension pivot such that when the second handle extension is in the third sliding position and is rotated from the first rotatable position to the second rotatable position, the second pin passes into the third pin receiving channel; and
the second handle extension having therein a fourth pin receiving channel parallel to the second elongated pivot channel and communicating with an end of the third pin receiving channel, such that when the second handle extension is slid from the third sliding position to the fourth sliding position, the second pin passes from the third pin receiving channel into the fourth pin receiving channel.

It is therefore yet another aspect, advantage, objective and embodiment of the invention to provide a pair of gardening shears wherein the second pin receiving channel has a length of at least 0.50 inches.

It is therefore yet another aspect, advantage, objective and embodiment of the invention to provide a pair of gardening shears wherein the first pin receiving channel has a length of at least 0.25 inches.

It is therefore yet another aspect, advantage, objective and embodiment of the invention to provide a pair of gardening shears wherein the first and second shear blades have a length of at least 1.25 inches.

It is therefore yet another aspect, advantage, objective and embodiment of the invention to provide a pair of gardening shears wherein the first distance is at least 0.625 inches.

It is therefore yet another aspect, advantage, objective and embodiment of the invention to provide a pair of gardening shears further comprising:
at least one tool selected from the group consisting of: a peeler blade, a serrated knife blade, a soil knife, a weeder, a concrete crevice cleaner, a saw blade, and combinations thereof, the selected tool being rotatably attached to the pivot.

It is therefore yet another aspect, advantage, objective and embodiment of the invention to provide a pair of gardening shears wherein the first shear pivot is located at a first end of the first handle and wherein the first extension pivot is located at a second end of the handle, and wherein at least a portion of the second pin receiving channel is located between the first and second ends of the handle.

### BRIEF DESCRIPTION OF THE DRAWINGS

FIG. 1 is a left side elevational perspective view of the invention in the folded shears position and folded handles position.

FIG. 1a is a left side elevational perspective view of the invention still in the folded handles position but now shown partially from the folded shear position to the open shear position.

FIG. 2 is a right side elevational perspective view of the invention with the handles still in the folded position but the shears now in the open/unfolded position: note that after the unfolding operation, the invention has been rotated 180 degrees from the left side view of FIG. 1.

FIG. 3 is a right side elevational perspective view of an embodiment of the invention with one handle unfolded into the open position.

FIG. 4 is a right side elevational perspective view of the preferred embodiment of the invention with two handles unfolded into the open position.

FIG. 5 is a partially transparent side view of one handle of the invention (the main pivot, shears and other handle omitted for clarity) in the handle closed position.

FIG. 6 is a partially transparent side view of one handle of the invention partially opened, with the handle pivot at a position to allow the pin to be received into the first pin receiving channel.

FIG. 7 is a partially transparent side view of one handle of the invention opened with the pin shown in mid-travel down the first pin receiving channel.

FIG. 8 is a partially transparent side view of one handle of the invention open, with the handle pivot in a position to lock the pin firmly into the second pin receiving channel and out of the first pin receiving channel.

FIG. 9 is a bottom view of a handle, showing the widths of the handle, the handle extension channel and tools within the handle channel.

FIG. 10 is a partially transparent side view of an alternative embodiment of one handle of the invention in the position in which the handle extension is open, with the pin firmly placed in the second pin receiving channel.

### INDEX OF REFERENCE NUMERALS

Gardening tool 100
Lower handle 102
Upper handle 104
Gardening shears 106
Fingernail nick 108
Upper blade 110a
Lower blade 110b
Upper cutting edge 112a
Lower cutting edge 112b
Main pivot 114
Shear pivots 116, 118
Upper blade back edge 120
Lower blade back edge 122
Gardening tool 200
Lower handle 202
Upper handle 204
Upper handle extension 205
Fingernail nick 208
Extension nick 208a
Extension pivot 230
Pivot channel 232
Shear pivot gap 234
Extension hook 236
Gardening tool 300
Lower handle extension 305
Extension pivot 330
Pivot channel 332
Shear pivot gap 334
Extension hook 336
Gardening tool 400
Handle 402
Handle extension 405 Extension pivot 430
Pivot channel 432
Shear pivot gap 434
Tool head 440
First pin receiving channel 442
Second pin receiving channel 444
Pin 446
First slidable pivot position 448
Second slidable pivot position 450
First pin position 452
Second pin position 454
Third pin position 456
Lock mechanism lever distance 458
Shear pivot 460
Second pin receipt channel length 462
Handle 502
Handle extension 505
Tools 540
Handle extension channel/channel width/maximum handle width 570
Handle channel width 572
Second pin receiving channel 644

### DETAILED DESCRIPTION

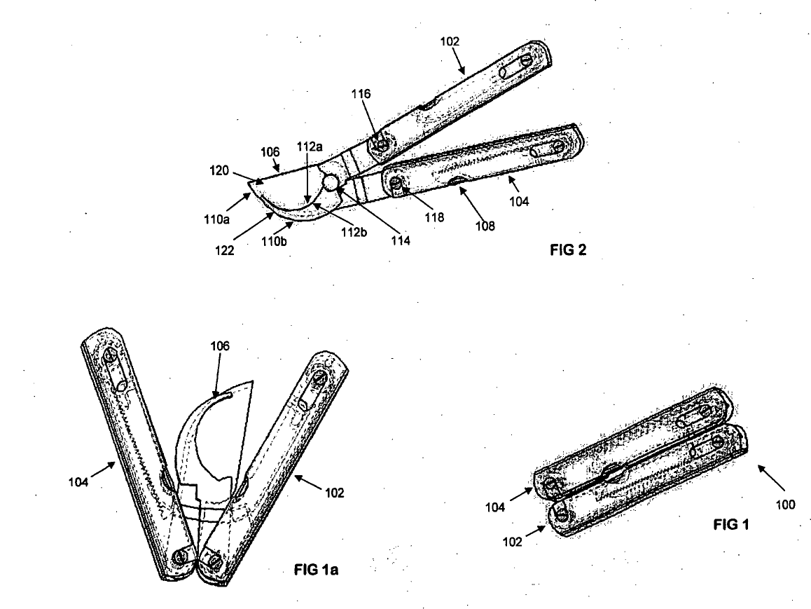

FIGS. 1 through 4 show the steps in unfolding two embodiments of the invention: one having a single folding handle and one having two folding handles. FIG. 1 is a left side elevational perspective view of the invention in the folded shears position and folded handles position. In this position, the device is completely closed. FIG. 1a is a left side elevational perspective view of the invention still in the folded handles position but now shown partially from the folded shear position to the open shear position. This position is one which the device might attain at an early stage of unfolding or a late stage of folding: the heavy duty pruning shears of the invention are visible still partially nested within the channels of the handles.

FIG. 2 is a right side elevational perspective view of the invention with the handles still in the folded position but the shears now in the open/unfolded position: note that after the unfolding operation, the invention has been rotated 180 degrees from the left side view of FIG. 1. The invention may be used in this position, albeit with a greatly reduced lever arm.

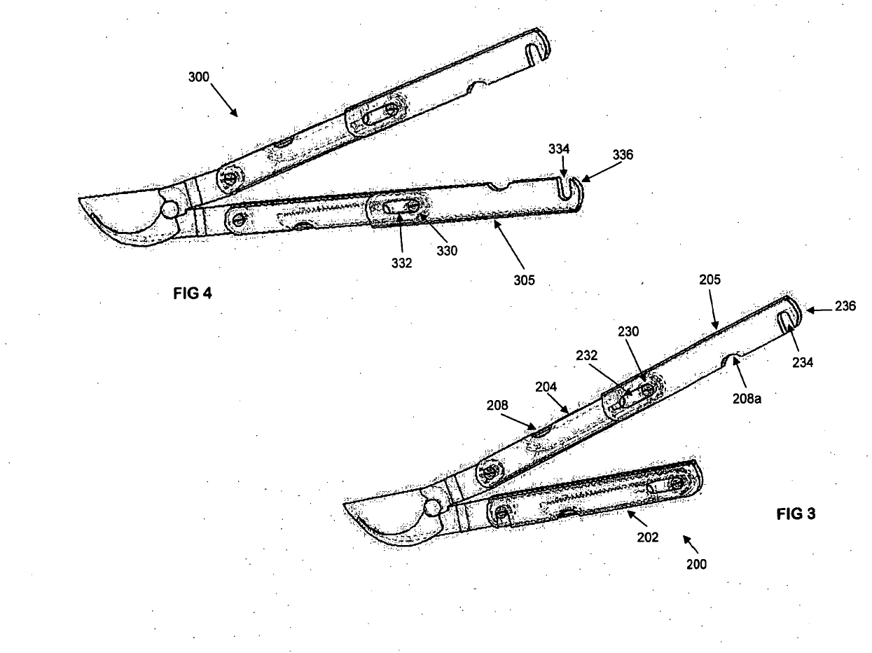

FIG. 3 is a right side elevational perspective view of an embodiment of the invention with one handle unfolded into the open position, whereas FIG. 4 is a right side elevational perspective view of the preferred embodiment of the invention with two handles unfolded into the open position. For embodiments in which both handles unfold, FIG. 3 may be a precursor to FIG. 4.

Gardening tool 100 has lower handle 102 and upper handle 104, used to close or open gardening shears 106. Fingernail nick 108 may be used to provide easy access to further gardening tools stored folded in the handles 102, 104.

Upper blade 110a and lower blade 110b have respective upper cutting edge 112a and lower cutting edge 112b as well as upper blade back edge 120 and lower blade back edge 122. The shape of the blades is sharply asymmetrical and of a particular shape, due to the fact that the shears structures are gardening structures and not for use with wire stripping, paper cutting, pliers structures. Upper blade 110a is broad and substantially straight backed for additional strength: the broader blade and greater depth allow a narrower blade in cross section to remain strong. This is extremely important for use in gardening applications. A wire cutter may typically have a short blade with little depth, as wires have almost no depth. A narrow blade is a necessary structure in order to allow the blade to penetrate a distance into a wide wooden or woody object such as a weed or tree limb: a shallow blade simply cannot penetrate the distance, a blade not narrow would meet great resistance as it sank into the tough wood. Lower blade 110b having lower cutting edge 112b and lower blade back edge 122 is also necessary structure for cutting deeper more resilient objects such as are found in gardens and arbors. Lower blade 110b is firstly thicker than it's mate so as to allow greater strength in a smaller depth, thus leaving more depth in the overall shears size-envelope (limited by the space available inside the handles) for the necessarily narrower cutting blade. Lower cutting edge 112b is also sharply curved so that the entire lower blade 110b acts as a “hook” which passes around a generally round object of diameter larger than wire and diameter up to the length of the lower blade 110b. When in use the hook-shape of the lower blade 110b holds the object in place despite the enormous pressures exerted at the exact cutting edge of the upper blade 110a. (A mere ten pounds of force easily applied one handed via the handles and transmitted to a cutting edge one inch long and 0.015625 inch wide at the edge produces a pressure along the cutting edge of 640 pounds per square inch, due to the small size of the incident edge. In actual practice, amounts of force much greater than a mere ten pounds are often employed in cutting wood, pulpy weeds, roots, slats, vines and the like.) Producing pressures like this is not possible with typical plier structures nor with scissors designed and structured for more mundane cutting operations.

Main pivot 114 must be of strong construction to allow easy transmission of force from the handles to the cutting edges, particularly as the locking mechanism of the invention is specifically designed to allow the user to employ much greater force than known designs. Main pivot 114 rotatably connects the handles of the invention to the blades and has provides to the blades and the handles a range of positions from fully open to fully closed.

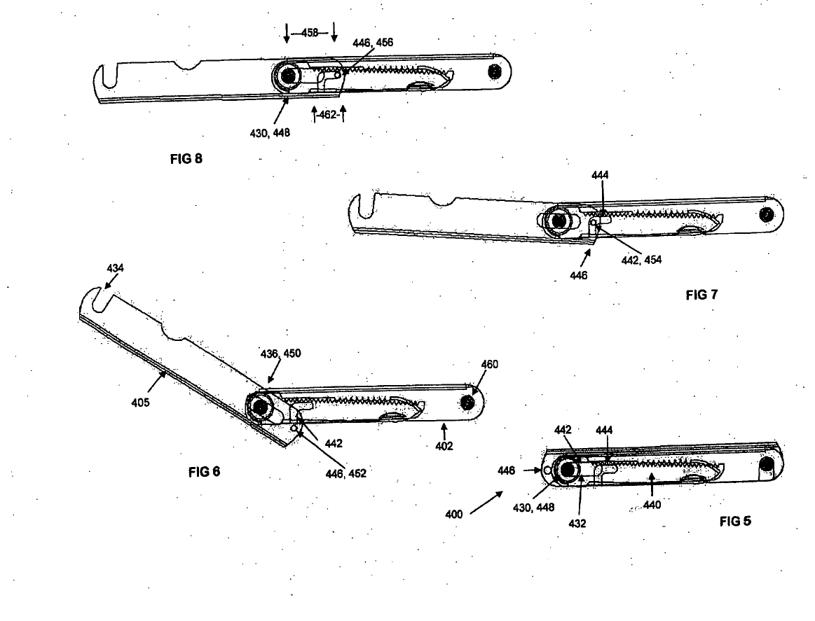

Shear pivots 116, 118 will be discussed in greater detail in regard to FIGS. 5 through 8, at this juncture is merely worth noting that shear pivots 116, 118 provide rotatable connections of the handles and the handle extensions in positions from fully nested together to fully extended apart, and further provide a slidable connection of the handles and handle extensions in positions from unlocked for rotation to locked to prevent rotation.

Gardening tool 200 may be considered to illustrate an intermediate step from FIG. 2 to FIG. 4, however, it is an alternative embodiment which has a single handle using the locking mechanism of the invention. Lower handle 202 is as previously described. Upper handle 204 has upper handle extension 205 rotatably connected to it at the end distal the shears and main pivot. (The identity of upper and lower handles 202, 204 may be interchanged, as which one is “upper” and “lower” will depend upon the stage of folding/unfolding pictured.) Fingernail nick 208 (and complementary extension nick 208a) may be used to allow access to tools folded within the handle channel.

Extension pivot 230 provides the rotatable attachment of handle 204 to extension 205. Pivot channel 232 is an elongated channel through extension 205 which allows extension pivot 230 to slide to a variety of positions in the channel, thus allowing the handle 204 and extension 205 to slide relative to each other.

Shear pivot gap 234 allows the handle extension 205 to be of a greater length, thus allowing application of greater torque to the device in use. Extension hook 236 is formed by shear pivot gap 234, forming another useful gardening tool located at the end of handle extension 205 distal from the extension pivot 230.

In use, two hands may be used with the device: one on the lower handle and one on the handle extension.

In the presently preferred embodiment and best mode presently contemplated for carrying out the invention, gardening tool 300 has not one but two handles which may be extended. Lower handle extension 305 connects to extension pivot 330 which connects to the lower handle. Pivot channel 332 also allows sliding between two positions, one which the lock mechanism may rotate and one in which it is locked.

Shear pivot gap 334 and extension hook 336 are much as described in reference to FIG. 3.

FIG. 5 is a partially transparent side view of one handle of the invention (the main pivot, shears and other handle omitted for clarity) in the handle closed position, leading to FIG. 6 which is a partially transparent side view of one handle of the invention partially opened, with the handle pivot at a position to allow the pin to be received into the first pin receiving channel. FIG. 7 is then a partially transparent side view of one handle of the invention opened with the sturdy protruding pin shown in mid-travel down the first pin receiving channel as the locking operation is commenced and FIG. 8 shows the completion of the locking in a partially transparent side view of one handle of the invention open, with the handle pivot in a position to lock the pin firmly into the second pin receiving channel and out of the first pin receiving channel.

Gardening tool 400 (partial depiction) has handle 402 having handle extension 405 connected by extension pivot 430 sliding in pivot channel 432. Shear pivot gap 434 again allows a longer handle to seat over pivots at the shear end of the handle.

Tool head 440 may be any of a variety of folding tools structured for gardening, including but not limited to: a peeler blade for grafting plants, a serrated knife for green plant cuttings, soil knife for stirring soil, a weeder for removal of weeds from earth, concrete crevice cleaners, a saw blade, as well as more general purpose tools such as screwdrivers, can openers, files, rulers, a flat blade knife for general purpose use, a clip blade knife and combinations thereof. These tools may be of special design or may be known in the prior art.

Crucial to the success of the invention is a locking mechanism capable of withstanding very large imposed torques. While folding handles on a gardening shears have been discussed and the necessary structure of pruning shears has been discussed, these cannot function to allow users to operate stronger shears at higher torque unless a locking mechanism which is both easy to use and able to withstand great torque is developed. Certain prior art non-gardening structure devices show “ears” which latch into short channels very close to a pivot point: in use, such devices would allow the handles to fold smaller but would not allow the imposition of greater torques.

The present invention teaches a locking mechanism with a long baseline and secure mechanism, allowing the device to absorb much greater torque from the handles and pass it safely via the main pivot to the pruning shears. First pin receiving channel 442 and second pin receiving channel 444 will receive sturdy protruding pin 446 during motion of the handle extension 405 from the folded to unfolded position. Channels 442 and 444 may advantageously form an “L” or “V” shaped channel having two arms at right angles (perpendicular to each other) and communicating to one another at one end of each channel, at a right angle turn. One of the arms (second channel 444) may be parallel to the elongated pivot channel while the other arm (first channel 442) may be parallel to the direction of rotation about the extension pivot 430 but straight, which combines with the right angle junction of the two channels to provide improved retention of pin 446 in the two channels. Retention of pin 446 in the two channels is important to the safe use of the invention, particularly when the device is used with high torques. Thus, channel 444 should also be at least 0.5 inch to 0.75 inch long, preferably more than 1.00 inch long.

In distinction, prior art devices show notches which are extremely short or which do not feature right angle turns and thus allow anything such as an “ear” within the notch to easily slide out. Most importantly, prior art devices with short notches do not allow for long lever arms in the locking mechanism, which long lever arms are necessary to provide a more sturdy locking mechanism able to withstand considerable force.

In embodiments, additional security may be gained by increasing the length of the second channel even more, and more importantly, by arranging the channels to meet at angles exceeding 90 degrees.

First slidable pivot position 448 shows the position of the pivot in the elongated pivot channel 432 when the device is folded. Second slidable pivot position 450 is the position of the pivot in the elongated pivot channel during the rotation motion of the handle extension 405 in relation to the handle 402 about the axis of pivot 430. This second position is dimensioned and configured to ensure that the pin 446 may enter the first pin receiving channel 442.

First pin position 452 in fact shows the pin about to enter the first pin receiving channel 442, while second pin position 454 shows the pin in the first channel 442 and approaching the second channel 444, but not yet securely locked into place.

Third pin position 456 shows the pivot 430 and pin 446 in their final locked positions. Pin 446 is located at the extreme distal end of the second pin receipt channel 444. It can only come dislodged by an ordered application of forces in different directions, meaning that in use it is extremely unlikely to come loose accidentally. Second pin receipt channel length 462 is also important to proper functioning of the device. The length of this channel, at least 0.5 inch, preferably more than 0.75 inch and in alternative embodiments one inch or more, is a further security structure preventing accidental folding of the handle extension during use.

In addition, the second pin receiving channel length 462 is a component of lock mechanism lever distance 458, which an extended distance measured from pivot 430 to pin 446 at the end of the second channel 444. This extended distance (which may increase as a function of second channel length 462 or may be increased independently thereof) means that the device has a long lever arm to resist torque. The lever distance of the locking mechanism may advantageously be at least 0.625 inch, preferably at least 0.875 inch, and may in embodiments be several inches.

This extended distance further requires that pin 446, extension pivot 430, and channels 442, 444 be of sturdy construction to resist these forces: actual pins might be preferable to ears and notches made in the material of the handles/extension.

The present invention teaches a sturdy locking mechanism which has a considerably longer lever distance 458, which in turn allows application of greater forces to the handles/extensions during use, which in turn opens up the use of heavier duty cutting implements such as gardening shears.

Shear pivot 460 located that other (proximal) end of the handle 402 rotatably connects the handle to the heavy duty shears.

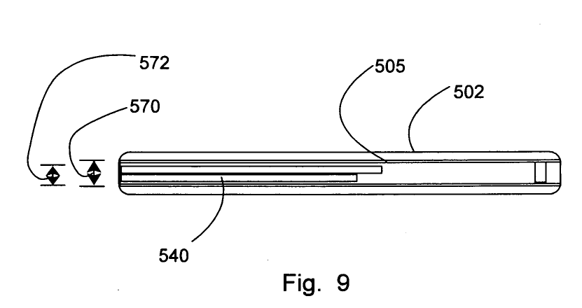

FIG. 9 is a bottom view of a handle, showing the widths of the handle, the handle extension channel and tools within the handle channel. Handle 502 and handle extension 505 have within them channels, depicted by arrows showing widths: arrow 570 shows the width of the handle extension channel and thus also the maximum width of the handle itself nested within the handle extension. Arrow 572 shows the width of the handle channel, containing within it tools 540.

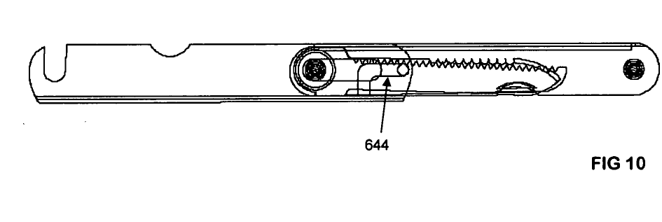

FIG. 10 is a partially transparent side view of an alternative embodiment of one handle of the invention in the position in which the handle extension is open, with the pin firmly placed in the second pin receiving channel.

It will immediately be appreciated that unlike prior art folding handle designs, the present invention has a structure which may be scaled up to longer and longer lever arms, thus allowing sturdier and sturdier locking mechanisms. Second pin receiving channel 644 is considerably displaced from the extension pivot. The handle has two ends, with the shear pivot at a first end and the extension pivot at the second end. The second pin receiving channel 644 has an end which may be final “locked” position of the pin, and this end is not located at either of the ends of the handle but rather is located in between the ends of the handle, at a distance from the extension pivot with which it forms a lever arm.

It will be appreciated that the design of the channels and sides of the handles and handle extensions may also be optimized to allow the application of greater torque to the device, however, regardless of such configurations of the handles and handle extensions, the locking mechanism must be able to withstand considerable torque while stabilizing the pivoting joint or the device will collapse on application of “tree pruning” forces to the handles.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

1. An improved pair of gardening shears, having a handle and handle extension rotatably connected by a pivot passing through both handle and handle extension, wherein the improvement comprises:
first and second shear blades;
an elongated pivot channel through which the pivot passes;
at least one protruding pin located at a first distance from the pivot;
a first pin receiving channel parallel to the direction of rotation of the pivot and having an open first end located at the first distance from the pivot and having a second end, and a second pin receiving channel perpendicular to the first pin receiving channel and parallel to the elongated pivot channel and communicating with the second end of the first pin receiving channel.

2. The improved pair of gardening shears of claim 1, wherein the second pin receiving channel has a length of at least 0.50 inches.

3. The improved pair of gardening shears of claim 1, wherein the first pin receiving channel has a length of at least 0.25 inches.

4. The improved pair of gardening shears of claim 1, wherein the first and second shear blades have a length of at least 1.25 inches.

5. The improved pair of gardening shears of claim 1, wherein the first distance is at least 0.625 inches.

6. The improved pair of gardening shears of claim 1, wherein the first and second shear blades are curved.

7. The pair of gardening shears of claim 1, further comprising:
at least one tool selected from the group consisting of: a peeler blade, a serrated knife blade, a soil knife, a weeder, a concrete crevice cleaner, a saw blade, and combinations thereof.

8. The pair of gardening shears of claim 1, wherein the first and second pin receiving channels form a single L-shaped pin retainer.

9. The pair of gardening shears of claim 1, wherein such handle extension folds to a first position nested within the handle and to a open second position.

10. A pair of gardening shears comprising:
first and second handles rotatably connected at a main pivot, the first and second handles having respective first and second shear blades facing each other to form a set of shears, at least the first handle having a longitudinal handle channel having a width greater than the width of the main pivot and greater than the width of the shear blades; the first and second shear blades being curved;
at least the first handle having a handle extension, a shear pivot and an extension pivot;
the first handle extension rotatably connected to the first handle by the extension pivot, the handle extension having a longitudinal extension channel having a width greater than the width of the first handle, the handle extension having an elongated pivot channel through which the extension pivot passes;
the first handle rotatably connected to the main pivot by the shear pivot;
the first handle having a first position in which the main pivot and shear blades nest within the longitudinal handle channel and a second position in which the main pivot and shear blades extend from the first handle;
the handle extension having a first rotational position in which the first handle nests therein and a second rotational position in which the first handle extends from the handle extension and a third sliding position in which the extension pivot is located at a first part of the pivot channel and a fourth sliding position in which the extension pivot is located at a second part of the pivot channel;
the handle having protruding therefrom at least one pin; the handle extension having therein a first pin receiving channel parallel to the direction of rotation of the extension pivot and located at a distance from the extension pivot such that when the handle extension is in the third sliding position and is rotated from the first rotatable position to the second rotatable position, the pin passes into the first pin receiving channel; and
the handle extension having therein a second pin receiving channel perpendicular to the first pin receiving channel and parallel to the elongated pivot channel and communicating with an end of the first pin receiving channel, such that when the handle extension is slid from the third sliding position to the fourth sliding position, the pin passes from the first pin receiving channel into the second pin receiving channel.

11. The gardening shears of claim 10, further comprising:
a second handle having a second handle extension, a second shear pivot and a second extension pivot;
the second handle extension rotatably connected to the second handle by the second extension pivot, the second handle extension having a second longitudinal extension channel having a width greater than the width of the second handle, the second handle extension having a second elongated pivot channel through which the second extension pivot passes;
the second handle rotatably connected to the main pivot by the second shear pivot;
the second handle having a first position in which the main pivot and shear blades nest within the second longitudinal handle channel and a second position in which the main pivot and shear blades extend from the second handle;
the second handle extension having a first rotational position in which the second handle nests therein and a second rotational position in which the second handle extends from the second handle extension and a third sliding position in which the second extension pivot is located at a first part of the second pivot channel and a fourth sliding position in which the second extension pivot is located at a second part of the second pivot channel;
the second handle having protruding therefrom at least a second pin;
the second handle extension having therein a third pin receiving channel parallel to the direction of rotation of the second extension pivot and located at a distance from the second extension pivot such that when the second handle extension is in the third sliding position and is rotated from the first rotatable position to the second rotatable position, the second pin passes into the third pin receiving channel; and
the second handle extension having therein a fourth pin receiving channel perpendicular to the third pin receiving channel and parallel to the second elongated pivot channel and communicating with an end of the third pin receiving channel, such that when the second handle extension is slid from the third sliding position to the fourth sliding position, the second pin passes from the third pin receiving channel into the fourth pin receiving channel.

12. The improved pair of gardening shears of claim 10, wherein the second pin receiving channel has a length of at least 0.50 inches.

13. The improved pair of gardening shears of claim 10, wherein the first pin receiving channel has a length of at least 0.25 inches.

14. The improved pair of gardening shears of claim 10, wherein the first and second shear blades have a length of at least 1.25 inches.

15. The improved pair of gardening shears of claim 10, wherein the first distance is at least 0.625 inches.

16. The pair of gardening shears of claim 10, further comprising:
at least one tool selected from the group consisting of: a peeler blade, a serrated knife blade, a soil knife, a weeder, a concrete crevice cleaner, a saw blade, and combinations thereof, the selected tool being rotatably attached to the pivot.

17. The pair of gardening shears of claim 10, wherein the first shear pivot is located at a first end of the first handle and wherein the first extension pivot is located at a second end of the handle, and wherein at least a portion of the second pin receiving channel is located between the first and second ends of the handle.
